(19) United States
(12) Patent Application Publication
(10) Pub. No.: US 2026/0036291 A1
(43) Pub. Date: Feb. 5, 2026

(54) FLOOD LIGHT

(71) Applicant: MILWAUKEE ELECTRIC TOOL CORPORATION, Brookfield, WI (US)

(72) Inventors: Jeremy A. Schmittinger, Waukesha, WI (US); Peter G. Diamond, West Allis, WI (US); Christina Y. Prestidge-Kadrlik, Pewaukee, WI (US); Ashton L. Krepelkam, Shorewood, WI (US); Megan N. Wasmer, Oak Creek, WI (US); Andrew R. Eder, Whitefish Bay, WI (US); Matthew J. Johnson, Oconomowoc, WI (US); Gregory A. Mutchler, Milwaukee, WI (US); Matthew D. Bakich, Hartford, WI (US)

(21) Appl. No.: 19/290,964

(22) Filed: Aug. 5, 2025

Related U.S. Application Data
(60) Provisional application No. 63/679,379, filed on Aug. 5, 2024.

(51) Int. Cl. F21V 21/30; F21V 23/00; F21V 23/04; F21Y 105/16

(52) U.S. Cl. CPC F21V 21/30; F21V 23/009; F21V 23/0435; F21Y 2105/16

(57) ABSTRACT

A light assembly may include a housing configured to couple to a power supply. A light assembly may include a first light panel with a spot light mounted thereto, the first light panel being pivotably coupled to the housing by a first hinge. A light assembly may include a second light panel with a flood light mounted thereto, the second light panel being pivotably coupled to the first light panel by a second hinge.

### CROSS-REFERENCE TO RELATED APPLICATIONS

This application claims priority to U.S. Provisional Patent Application No. 63/679,379, filed on Aug. 5, 2024, and entitled “Flood Light”, the contents of which are hereby incorporated herein by reference in their entirety.

### FIELD OF THE INVENTION

The present disclosure relates to flood lights and, more particularly, to flood lights with both spot lights and flood lights.

### SUMMARY

In some aspects, the techniques described herein relate to a light assembly including: a housing configured to couple to a power supply; a first light panel with a spot light mounted thereto, the first light panel being pivotably coupled to the housing by a first hinge; and a second light panel with a flood light mounted thereto, the second light panel being pivotably coupled to the first light panel by a second hinge.

In some aspects, the techniques described herein relate to a flood light system including: a first light assembly including a first housing configured to be coupled to a first power supply, at least one first light panel with a first light, and at least one first frame tube defining a first recess; and a second light assembly including a second housing configured to be coupled to a second power supply, at least one second light panel with a second light, and at least one second frame tube defining a second recess; and a protrusion engaging the first recess and the second recess to connect the first light assembly with the second light assembly.

In some aspects, the techniques described herein relate to a light assembly including: a housing configured to couple to a power supply; a first light panel with a first light mounted thereto, the first light panel being pivotably coupled to the housing by a first hinge; a second light panel with a second light mounted thereto, the second light panel being pivotably coupled to the first light panel by a second hinge; and a frame coupled to the housing, the frame including at least one frame tube defining a recess configured to be engaged by at least one of a protrusion or hook to secure the frame to a support.

Other aspects of the invention will become apparent by consideration of the detailed description and accompanying drawings.

### BRIEF DESCRIPTION OF THE DRAWINGS

FIG. 1 is a front perspective view of a flood light in a deployed position and supported in a vertical orientation relative to a work surface.

FIG. 2 is a side view of the flood light of FIG. 1 in the deployed position and supported in the vertical orientation relative to the work surface.

FIG. 3 is a side view of the flood light in a stowed position.

FIG. 4 is a side view of the flood light in a deployed position and supported in a horizontal orientation relative to the work surface.

FIG. 5 is a cross-sectional view of exemplary frame members.

FIG. 6 is a side view of a flood light system including multiple flood light assemblies as supported by a ground surface or hung from a support hook.

FIG. 7 is a front perspective view of another flood light in a deployed position.

FIG. 8 is a rear perspective view of the flood light of FIG. 7 in the deployed position.

FIG. 9 is a front perspective view of the flood light of FIG. 7 in another deployed position.

FIG. 10 is a front perspective view of the flood light of FIG. 7 in a partially deployed position.

FIG. 11 is a front perspective view of the flood light of FIG. 7 in a stowed position with panels thereof facing outwardly.

FIG. 12 is a rear perspective view of the flood light of FIG. 7 in a stowed position with panels thereof facing inwardly.

FIG. 13 is a side perspective view of the flood light of FIG. 7 in a deployed position and supported by hooks.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

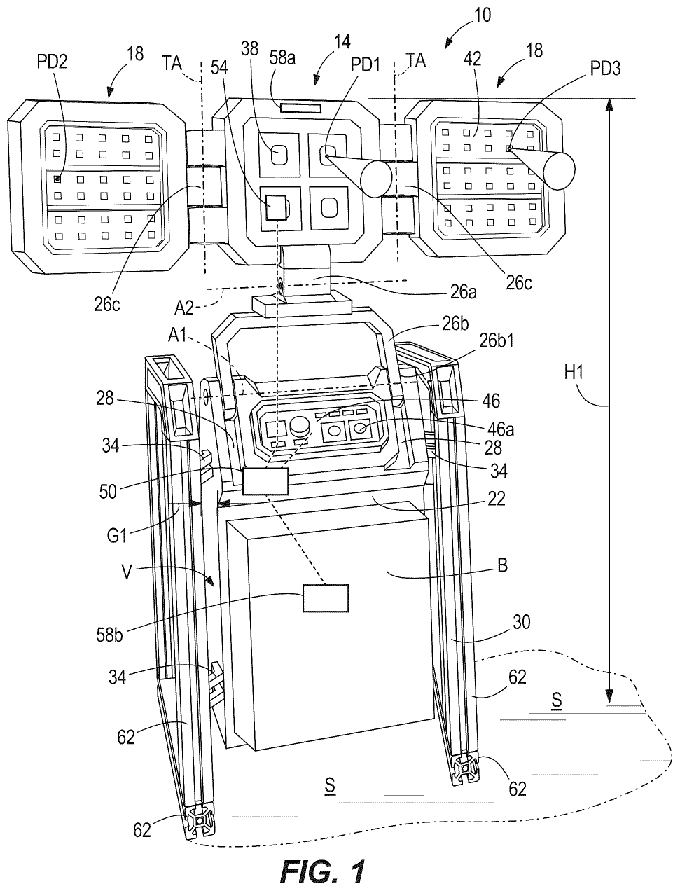

FIGS. 1-4 illustrate a flood light assembly 10 for use with a battery B. The battery B may be a battery pack, such as Milwaukee Tool's MX FUEL Lithium-Ion REDLITHIUM battery pack. Other battery packs and/or other types of power supplies may supply electrical power to the flood light assembly. The flood light assembly 10 may be referred to as an area light, a work light, a site light, or a stand light. The flood light assembly 10 may be used to illuminate a worksite or other type of target area surrounding the flood light assembly 10. The illustrated flood light assembly 10 includes a central panel 14 (i.e., first light panel) and two side panels 18 (i.e., second light panels). The central panel 14 is connected to a main body (i.e., housing) 22 of the flood light assembly 10 by a first hinge 26a and a yoke arm 26b (i.e., second hinge). The first hinge 26a is pivotable about axis A2 and may optionally be a multi-axis hinge also pivotable about a central panel twist axis through the center of the first hinge 26a (as described below regarding main panel hinge 126a, central panel twist axis A3, and central panel stow axis A4). The yoke arm 26b (i.e., second hinge) is pivotable about axis A1. In the illustrated embodiment, the axes A1, A2 of the first hinge 26a and yoke arm 26b are parallel to one another. The first hinge 26a and yoke arm 26b (i.e., second hinge) function as a compound hinge. Side hinges 26c interconnect the side panels 18 to the central panel 14 with the side hinges 26c permitting the side panels 18 to rotate relative to the central panel 14 about a side panel twist axis TA. The hinges 26a-26c may include mechanical or other features to lock relative positions of the light panels 14, 18 in commonly used positions (e.g., the side hinges 26c may be configured to hold and/or bias the side panels 18 in the same plane as the central panel 14).

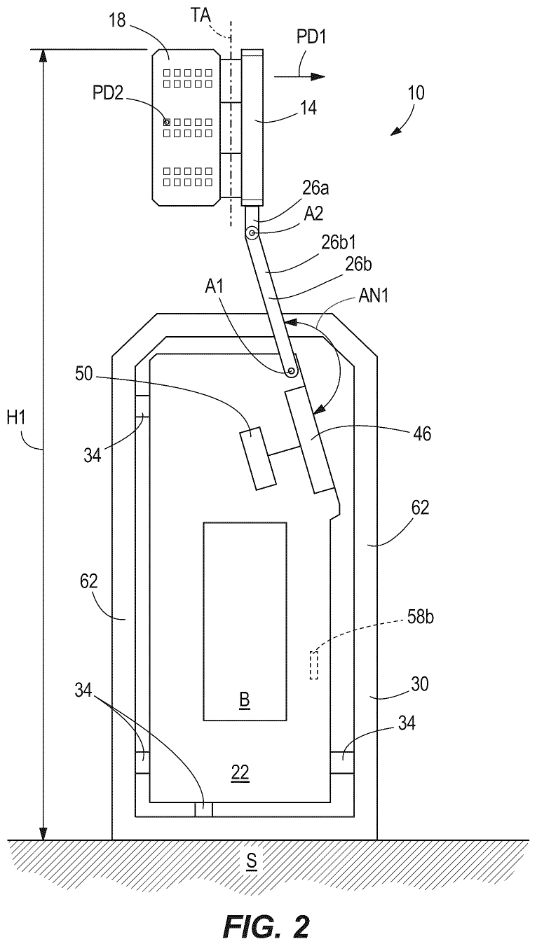

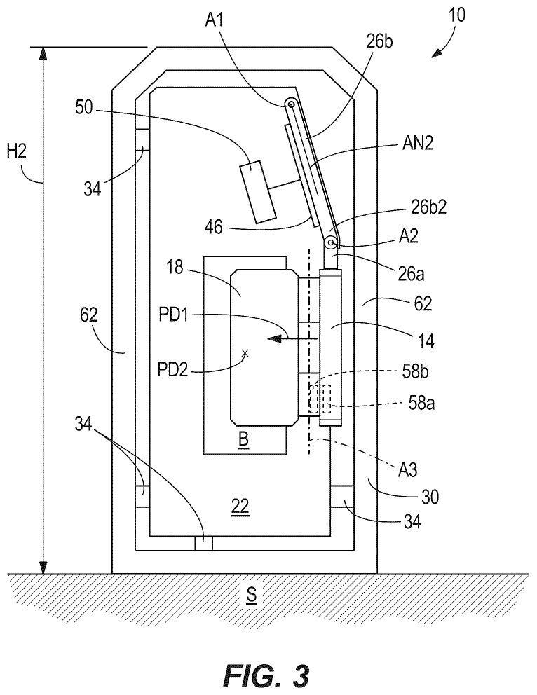

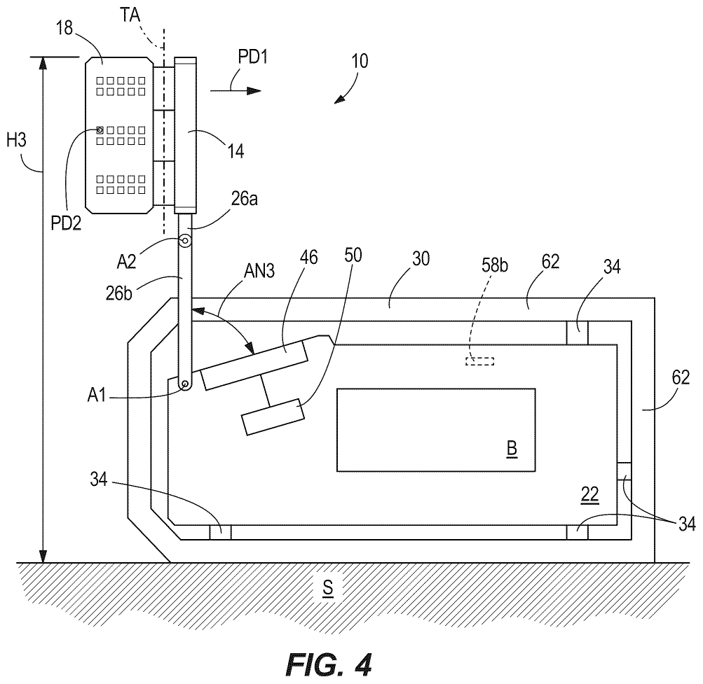

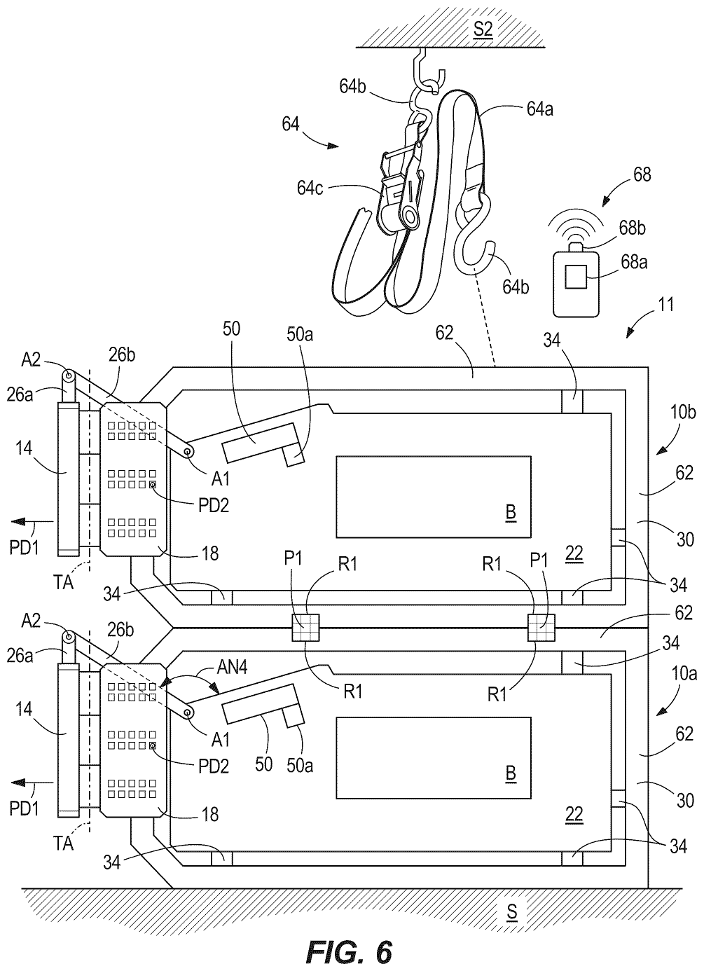

The central panel 14 is directed along panel direction PD1, and the side panels 18 are directed along side panel directions PD2, PD3, respectively. The central panel 14 and side panels 18 are orientable in a variety of orientations to orient the panel directions PD1-PD3 toward the target area. For example, the yoke arm 26b (i.e., second hinge) is movable between an extended position 26b1 and a seated position 26b2 in which the yoke arm 26b (i.e., second hinge) engages a channel 28 of the main body 22. In the extended position 26b1, the yoke arm 26b is positioned at angle AN1 (FIG. 2) relative to the main body 22, which in the illustrated embodiment is approximately 180 degrees. In the seated position 26b2, the yoke arm 26b is positioned at angle AN2 (FIG. 3) relative to the main body 22, which in the illustrated embodiment is approximately 0 degrees, and the yoke arm 26b is generally received in the channel 28. The yoke arm 26b is also positionable in any number of positions between the seated position 26b2 and the extended position 26b1 such as represented by angle AN3 (FIG. 4) and angle AN4 (FIG. 6). The yoke arm 26b (i.e., second hinge) and channel 28 may each be generally U-shaped. The frame 30 and/or hinge 26 (when in the extended position 26b1) may function as a handle to permit a user to transport the flood light assembly 10 from worksite to worksite or to a desired location within range of a target.

The main body 22 is positioned at least partially within and secured to a frame 30 by one or more isolators 34. The isolators 34 may be made of material (e.g., rubber, elastomeric material, etc.) having mechanical damping properties to mitigate damage of the main body 22 and light panels 14, 18 when the frame 30 impacts a surface S following a drop. The isolators may be formed by elastomer bushings (e.g., circular or otherwise shaped) where the frame 30 is attachable to the inner diameter or outer diameter of the bushing (i.e., isolator 34), and the main body 22 (e.g., an electrical plastic enclosure) could attach to the other of the inner diameter or outer diameter of the bushing. Another mechanical feature (e.g., a shoulder) may be employed to axially retain the frame 30, isolator 34, and main body 22.

The central panel 14 may include at least one spot light 38, and each side panel 18 may include at least one flood light 42. Various permutations of type of lights present on the central panel 14 and side panel 18 are possible. For example, in other arrangements, the spot light 38 may be arranged on either side panel 18, and the flood light 42 may be arranged on the central panel 14. More or fewer panels 14, 18 are also possible (e.g., only one side panel 18, another side panel 18 attached by another hinge at a top of the central panel 14 as viewed in FIG. 1). In the illustrated embodiment, a plurality of spot lights 38 in the form of light emitting diodes (LEDs) are mounted to the central panel 14 in an array (i.e., spaced apart from one another in a pattern, for example a rectangular repeating pattern, along a surface of the central panel 14). In the illustrated embodiment, a plurality of flood lights 42 in the form of light emitting diodes (LEDs) are mounted to each side panel 18 in an array. As shown in FIG. 1, the spot lights 38 may emit light along the panel direction PD1 with a relatively concentrated light emission cone. In contrast, the food lights 38 may emit light along the panel directions PD2, PD3 with a relatively wide-case light emission cone.

During normal operation, the frame 30 and main body 22 are supported on the surface S, and at least one of the panels 14, 18 is deployed by actuating at least one of the hinges 26a-26c to direct at least one of the spot light 38 and flood light 42 by directing the panel direction(s) PD1(-PD3) toward a target area. The frame 30 may support the main body 22 in a vertical (i.e., upright) orientation (FIG. 1) whereby a length of the main body is oriented perpendicular from the surface S. Alternatively, the frame 30 may support the main body 22 in a horizontal (i.e., side) orientation (FIG. 4) whereby the length of the main body is oriented parallel with the surface S.

The flood light assembly 10 further includes a control panel 46. The control panel 46 includes one or more user interface 46a (e.g., buttons, touch pads, the like), and is electrically coupled to a controller 50. The user interface 46a may be actuated to supply current from the battery B to one or more of the spot lights 38 and/or flood lights 42. The controller 50 may be positioned within the main body 22. The control panel 46 may be positioned adjacent to and within the U-shape of the channel 28. The shape of the yoke arm 26b preserves user access and usability of the user interface 46a and control panel 46 independent of the position of the yoke arm 26b. The battery B may be positioned within the main body 22, partially within the main body 22, or between the main body 22 and a volume delimited by the frame 30. The user interface 46a and controller 50 may be further operable to increase brightness to change an intensity of at least one of the spot light 38 and the flood light 42.

The flood light assembly 10 may be operable, by user selection via the user input feature(s) in a flood light mode in which only one or more flood lights 42 is supplied with current and illuminated. The flood light assembly 10 may also be operable in a spot light mode in which only one or more spot lights 38 is supplied with current and illuminated. The flood light assembly 10 may also be operable in a flood and spot light mode in which both at least one flood light 42 and at least one spot light 38 are supplied with current and illuminated. The controller 50 may be programmed with any desired combination or subcombination of groupings of flood lights 42 and spot lights 38 to be illuminated. Operation of the hinges 26a-26d may be independent of the mode of the flood light assembly 10 such that both the one or more spot lights 38 and the one or more flood lights 42 that are illuminated in the flood and spot light mode shine upon the same target and/or different targets.

The controller 50 may be configured to constantly and/or intermittently monitor operation of the flood light assembly 10. The controller 50 may be configured to automatically shut off (i.e., deactivate) one or more of the panels 14, 18 an/or one or more of the individual spot lights 38 or flood lights 42 in response to a triggering condition.

For example, the controller 50 may actuate in an auto-shutoff manner upon detecting an overtemperature situation to avoid damage to the spot light 38 or flood light 42. While the spot light 38 or the flood light 42 are illuminated, electrical energy from the battery B may be converted to light and heat. The flood light assembly 10 may include a thermistor 54 to monitor temperature of, for example, the spot light 38 or the flood light 42. The thermistor 54 may directly measure the spot light 38 or the flood light 42, or may measure a temperature of the interior of the corresponding panel 14, 18. Alternatively, the thermistor 54 may measure temperature of a heat sink within the panel 14, 18 and corresponding with either the flood light 42 or the spot light 38. A plurality of thermistors 54 may be present. For example, one thermistor 54 may measure a spot light 38 of the central panel 14, and two additional thermistors 54 may measure a flood light 42 of the side panels 18. Alternatively, arrays of thermistors 54 for each individual spot light 38 of the array of spot lights 38 and/or for each individual flood light 42 of the array of flood lights 42 may be present. The thermistor or thermistors 54 can send a signal indicative of temperature to the controller 50, which can utilize the signal in comparison with a temperature threshold, to calculate whether an overtemperature situation is occurring whereby the sensed temperature of any one of the panels 14, 18 or lights 38, 42 exceeds a predetermined threshold temperature. Upon determining that one or more of the panels 14, 18 or lights 38, 42 is operating at overtemperature, the controller 50 may halt the supply of electrical current from the battery B to the overtemperature panel 14, 18 or light 38, 42.

Additionally or alternatively, the controller 50 may actuate in an auto-shutoff manner upon detecting a ‘light stowed’ situation whereby the hinges 26a-26c are articulated with the panel direction PD1 emitting light toward the housing 22 and in a direction that cannot possibly be aimed at a target without passing through the housing 22. The flood light assembly 10 may include one or more sensors to determine that one or more panels 14, 18 is stowed. For example, the flood light assembly 10 may include a hall effect sensor 58a and magnet 58b pair. When the hinges 26a-26c are articulated with the hall effect sensor 58a in close proximity to the magnet 58b, the hall effect sensor 58a can provide a signal indicative of one or more panels 14, 18 being stowed relative to the main body 22, and the controller 50 can calculate that the light stowed situation is occurring, and halt current from being sent to the corresponding stowed panel 14, 18 and/or the spot lights 38 or flood lights 42 of the stowed panel 14, 18. Sensors other than hall effect pairs may also be used. Auto-shutoff in response to detecting the light stowed situation can inhibit unnecessary waste of battery power and save the light elements 38, 42 from deteriorating when no useful/desired light is emitted by the assembly 10. For reference, FIG. 1 illustrates each of the light panels 14, 18 in a deployed position. In an exemplary stowed position (FIG. 3), the central panel 14 may be folded on the hinges 26a, 26b relative to the main body 22 thereby locating the hall effect sensor 58a and magnet 58b adjacent one another. The exemplary stowed position (FIG. 3) also illustrates the side panel 18 with the side panel oriented along panel direction PD2 extending toward the main housing 22, whereby light emitted by the flood elements 42 illuminate a side of the main body 22 and not a target exterior to the light assembly 10.

A thickness of the side panel 18 (measured parallel to the panel direction PD2) may be smaller than a lateral gap G1 between the frame 30 and the main housing 22. As such, when in the stowed position (FIG. 3), the side panel 18 may be positioned within a void V between the frame 30 and the main body 22. When stowed, each of the panels 14, 18 may be enclosed by a volume defined by the frame 30 such that when the flood light assembly 10 is inadvertently dropped onto a flat surface S, the panels 14, 18 do not contact the surface S.

The frame 30 of a single flood light assembly 10 may be made of a plurality of interconnected frame tubes 62. The frame tubes 62 of one flood light assembly 10 may be used to interconnect the flood light assembly 10 with another flood light assembly 10.

FIGS. 1-4 illustrate different total heights H1-H3 of the flood light assembly 10. In FIGS. 1-2, the flood light assembly 10 is fully deployed, and H1 represents a maximum height H1 from the support surface S to a top of the central panel 14 with the frame 30 in a vertical orientation upstanding from the support surface S. H2 (FIG. 3) represents a maximum height from the support surface S to a top of the frame 30 with the panels 14, 18 stowed within the frame 30. H3 represents a maximum height from the support surface to a top of the central panel 14 with the frame 30 in a horizontal orientation upstanding from the support surface S.

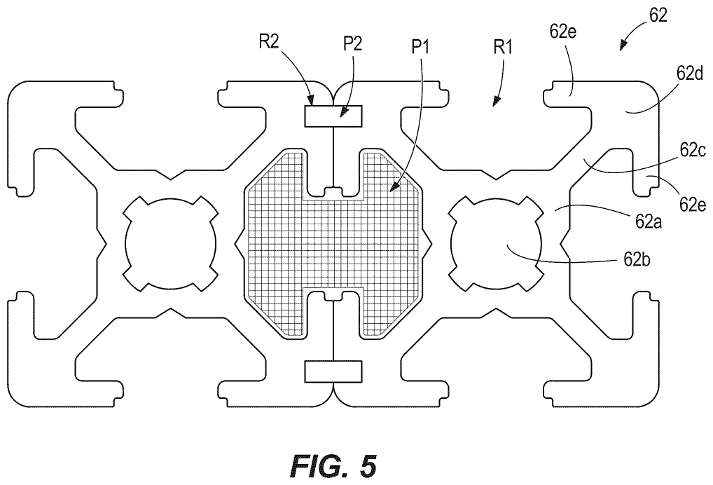

FIG. 5 illustrates two exemplary frame tubes 62 of two flood light assemblies 10. Each frame tube 62 defines a recess R1, R2 and is connected to one frame tube 62 by a protrusion P1, P2. The protrusion P1, P2 may hold the flood light assemblies relative to one another as assisted by one or more additional mechanical fasteners. The illustrated protrusion P1 may be a separate piece from the interconnected frame tubes 62. Alternatively, the illustrated protrusion P2 may be designed as integral with the frame tube 62. Both exemplary recesses R1, R2 are integral with the frame tubes 62.

FIG. 5 illustrates a cross-sectional view of two frame tubes 62 of two flood light assemblies 10. The frame tubes 62 may differ from one another while maintaining compatibility for mounting one flood light assembly 10 with one frame tube 62 with another flood light assembly 10 with another frame tube 62. Each frame tube 62 may provide one or more recesses R1, R2 capable of to receiving one or more protrusions P1, P2. In the illustrated embodiment, the frame tube 62 includes a central circular hub 62a with a central bore 62b. A plurality of outwardly extending arms 62c extend from the hub 62a to corners 62d. Corner arms 62e extending from the corners 62d may define a generally square shaped cross-sectional frame tube 62 that defines a recess R1 between adjacent corner arms 62e, the central hub 62a, and adjacent outwardly extending arms 62c. Other designs are possible.

FIG. 6 illustrates an exemplary stackable assembly flood light system 11 including a first flood light assembly 10a and a second flood light assembly 10b. The hinges 26a-26c are operable to direct at least panel direction PD1 in a forward facing direction while the yoke arm 26b is deployed. Depending on the length of the yoke arm 26b, the central panel 14 may be positioned within a volume defined by the frame 30 (e.g., as enclosed by the frame tubes 6). In other embodiments, the central panel 14 may project outwardly of the volume defined by the frame 30, and the side panels 18 may be deployable even with the flood light assembly 10a stacked onto one or more other flood light assemblies 10b. FIG. 6 schematically illustrates two instances of recesses R1 for each flood light assembly 10a, 10b and one protrusion P1 for each pair of recesses R1. Differing numbers of instances of recesses R1, protrusions P1, and/or types of protrusions and recesses (e.g., like protrusion P2, recesses R2) are possible.

FIG. 6 illustrates the flood light assembly 10a resting on a ground surface S. Additionally or alternatively, the flood light system 11 may include one or more ratchet straps 64 capable of hanging the flood light system 11 to a support hook S2 to suspend the flood light system 11 hanging in a position spaced from the ground surface S. The ratchet straps 64 may include strap material 64a with hooks 64b at either end for connection to one or more of flood light assemblies 10a, 10b at one end and the support hook S2 at the opposite end. The hooks 64b and/or the strap material 64a may be couplable to either or both of the main body 22 and the frame 30. The ratchet straps 64 may be retractable for ease of storage and deployment. Light output can be directed by actuating the hinges 26a-26c toward a single target, with light output of each flood light assembly 10a, 10b being effectively multiplied as arranged in a totem pole type stack (e.g., similar to multiplying sound output in a speaker totem pole stack).

With continued reference to FIG. 6, the flood light system 11 may further include a remote control device 68. The controller 50 of each flood light assembly 10 may include a wireless transmitter 50a capable of receiving and/or sending signals. The remote control device 68 (e.g., a dedicated remote control, a cell phone, a personal computer) including a user interface 68a (i.e., a remote user interface) and a wireless transmitter 68b capable of sending and/or receiving signals may be capable of communicating with the wireless transmitter 50a. The remote control device 68 may be used to turn ON and/or OFF either, both, or a plurality of flood light assemblies 10a, 10b of the flood light system 11. Operation with the remote control device 68 may be beneficial especially when the flood light assemblies 10a, 10b are hung from a support hook S2 at a high, difficult to reach location from the ground surface S. One remote control device 68 can actuate flood light assemblies 10a, 10b of an attached food light system 11 and/or multiple flood light systems 11 each with one or more flood light assemblies 10a, 10b.

The flood light assembly 10 is portable, highly efficient, and safe. The flood light assembly 10 as a whole (e.g., including each of the flood lights 42 and each of the spot lights 38) may have an output of at least 10,000 lumens. The flood light assembly 10 may have a runtime of greater than 4 hours. The flood light assembly 10 may have a runtime of greater than 5 hours. The flood light assembly 10 may have a runtime of greater than 6 hours. In some embodiments, the flood light assembly (e.g., one of the flood light assemblies 10a, 10b) may have dimensions of approximately 10 inches by 10 inches by 15 inches (e.g., a total volume of approximately 1,500 cubic inches, approximately 25 liters). In other embodiments, the flood light assembly 10 may have dimensions of approximately 12 inches by 12 inches by 17 inches (e.g., a total volume of approximately 2450 cubic inches, approximately 40 liters). In other embodiments, the flood light assembly may have dimensions of approximately 8 inches by 8 inches by 13 inches (e.g., a total volume of approximately 832 cubic inches, approximately 13.6 liters). Total volume of one flood light assembly as listed above may reflect either the stowed position (e.g., FIG. 3) or the deployed position (e.g., FIG. 1).

The battery pack B may be a high efficiency, high capacity, and lightweight battery pack. The battery pack B may have a nominal voltage of at least 18 Volts, at least 40 Volts, or of 72 Volts. The battery pack B may have a nominal voltage of greater than 80 Volts. The battery pack B may have a charge time of around 90 minutes. The battery pack B may define a volume of less than 10 liters, less than 8 liters, less than 6 liters, or approximately 5.25 liters (320 cubic inches). The battery B may have an Amp-Hour rating of at least 5, at least 5.5, and optionally at least 6.

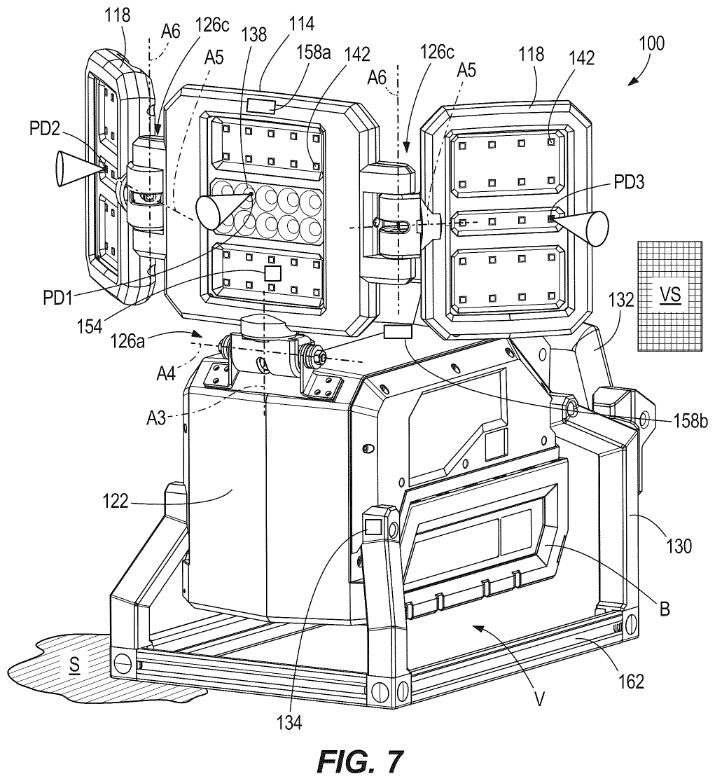

FIGS. 7-13 illustrate another embodiment of a flood light assembly 100 for use with the battery B. The flood light assembly 100 includes similar features to the flood light assembly 10 as marked with reference numerals plus ‘100’ with select modifications described in detail below. With reference to FIG. 7, the flood light assembly 100 includes a central panel 114 and two side panels 118. The central panel 114 is connected to a main body (i.e., housing) 122 of the flood light assembly 100 by a main panel hinge 126a. The main panel hinge 126a is a multi-axis hinge that permits rotation of the central panel 114 relative to the housing 122 about both a central panel twist axis A3 and a different central panel stow axis A4. The illustrated central panel twist axis A3 and central panel stow axis A4 of the main panel hinge 126a intersect, and more specifically, are orthogonal relative to one another. Each side panel 118 is connected to the central panel 114 by a side hinge 126c. The side hinges 126c of the flood light assembly 100 are multi-axis hinges that permit rotation of the two side panels 118 relative to the central panel 114 about both a side panel twist axis A5 and a side panel stow axis A6. The illustrated side panel twist axis A5 and side panel stow axis A6 of the side hinge 126c intersect, and more specifically, are orthogonal relative to one another.

The illustrated flood light assembly 100 does not include a yoke arm 26b, but other embodiments may include both a multi-axis main panel hinge 126a and a yoke arm like the yoke arm 26b to form a multi-axis compound hinge between the central panel 114 and the housing 122.

In the illustrated embodiment, the central panel 114 includes both spot lights 138 and flood lights 142, and the side panels 118 each include flood lights 142. In other embodiments, the central panel 114 may include only spot lights 138. The spot lights 138 and flood lights 142 may be selectively activatable by transferring current from the battery pack B thereto. As such, desired spot light, flood light, or combined spot and flood light may be emitted in in desired panel directions PD1, PD2, PD3. Desired activation may be controlled by user interaction with the user interface 146a, which functions with the controller 150 like that of the flood light assembly 10 to selectively supply current at desired levels for each of the spot lights 138 and flood lights 142 of the panels 114, 118. The controller 150 may be configured to send/receive with a remote control device 68 as described above. The panels 114, 118 may be moved via the main panel hinge 126a and side hinges 126c to physically orient the panel directions PD1, PD2, PD3 as desired for necessary spot and flood light orientation. For example, the central panel 114 may be oriented with the panel direction PD1 facing a specific target worksite area for emitting spot light (with spot lights 138 activated), flood light (with flood lights 142 activated), or combination spot and flood light (with both the spot lights 138 and flood lights 142 activated) thereon, and the side panels 118 may be oriented with panel directions PD2, PD3 thereof at other portions of the worksite area for emitting flood light (with flood lights 142 activated).

The flood light assembly 100 further includes a frame 130 including multiple frame tubes 162 attached to the housing 122. One or more of the frame tubes 162 may include geometry (e.g., cross-sectional geometry perpendicular to a length thereof) configured to interconnect the frame 130 with another object, such as another flood light assembly 10 (FIG. 1), another flood light assembly 100 (duplicate of FIG. 7 or another flood light assembly), a ratchet strap 64 (FIG. 6), or otherwise secure the flood light assembly 100 to surface S, support hook S2 (FIG. 6), or standing support VS. One or more of the frame tubes 162 may define a recess R1, R2, and be configured to be engaged by a protrusion P1, P2, or other accessory, as described above regarding the frame tubes 62. Optionally, one or more isolators 134 are attachable between the frame 130 and the housing 122. The flood light assembly 100 may include a handle 132 coupled to the frame 130. The handle 132 may be rigidly coupled to the frame 130. In other embodiments, the handle 132 may be loosely coupled to the frame 130 and permitted to rotate freely relative to the frame 130, for example, by gravity. The flood light assembly 100 may further include at least one thermistor 154 attached to any one or more of the central panel 114 and the two side panels 118.

FIG. 7 illustrates the frame 130 and frame tubes 162 supporting the housing 122 on the support surface S in a generally horizontal orientation with the housing 122 (e.g., a length and width dimension thereof) oriented generally parallel to the support surface S. Further, the horizontal orientation also orients the battery B generally parallel to the support surface S. The frame 130 and frame tubes 162 may be reoriented as desired by the user to support the housing 122 on the support surface S in a generally vertical orientation relative to the surface S as illustrated by the flood light assembly 10 in FIG. 1, with the housing 122 (e.g., the length and width dimension thereof) oriented upstanding from, or in other words, generally perpendicular to the support surface S.

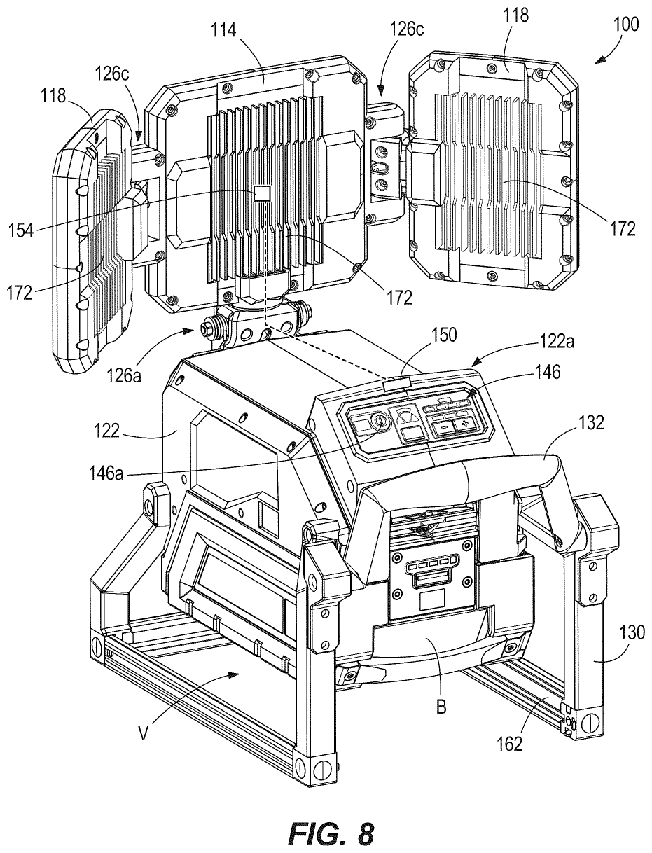

As illustrated in FIG. 8, the flood light assembly 100 may further include a control panel 146, user interface 146a, and controller 150 as described above with regard to the flood light assembly 10. The control panel 146 of the flood light assembly 100 is positioned at an opposite longitudinal side of the housing 122 in comparison to the main panel hinge 126a. The control panel 146 may be considered as being positioned at a rear of the housing 122, with the main panel hinge 126a being positioned at a front of the housing 122. With this arrangement, the control panel 146 may be accessible in various orientations of the central panel 114 as described below. Other embodiments may have the control panel 146 physically positioned at different locations on the housing 122. The control panel 146 may be positioned on a control panel portion 122a of the housing 122 that at least partially defines an outer profile thereof. The control panel portion 122a may protrude in an upward direction as viewed in FIG. 8 beyond the bounds of the remainder of the housing 122. The frame 130 and housing 122 together define an outer profile which defines the void V. The central panel 114 and two side panels 118 are positioned within the bounds of the void V when in the stowed position.

Each of the central panel 114 and two side panels 118 of the flood light assembly 100 include a heat sink 172 mounted on a rear surface thereof. The heat sink 172 may enhance heat dissipation capabilities of the central panel 114 and two side panels 118 to dissipate heat generated by the spot lights 138 and flood lights 142. The heat sinks 172 may be made of thermally conductive material and may optionally include one or more heat sink fins to increase effective heat transfer area between the corresponding panel 114, 118 and the ambient air surrounding the flood light assembly 100. Heat may be transferred (e.g., conducted) from the spot lights 138 and/or flood lights 142 to the heat sink 172, and transferred via convection from the heat sink 172 to the ambient air surrounding the flood light assembly 100.

The main panel hinge 126a and side hinges 126c permit the flood light assembly 100 to be stowed, deployed, and partially deployed and partially stowed in various positions and orientations. FIGS. 7-8 illustrate one deployed position of the flood light assembly 100 in which the central panel 114 is pivoted away from the housing 122 about the central panel stow axis A4 with the central panel 114 oriented as projecting generally perpendicularly away from the housing 122 and the surface S that supports the frame 130. In FIGS. 7 and 8, the side panels 118 are each pivoted about their corresponding side panel stow axis A6 to be non-planar with respect to the central panel 114. As such, the panel directions PD2, PD3 of the two side panels 118 extend away from one another. FIGS. 7-8 illustrate the panel directions PD2, PD3 oriented approximately 45 degrees outboard relative to the panel direction PD1 and at a similar height level to the central panel 114. However, the flood light assembly 100 is not limited in its range of motion to being oriented 45 degrees outboard relative to the panel direction PD1. Various other panel directions PD2, PD3 orientations are possible relative to the panel direction PD1. For example, lateral orientation of each side panel 118 relative to the central panel 114 may be further adjusted by pivoting the side panel 118 about the side panel stow axis A6, and vertical orientation of each side panel 118 relative to the central panel 114 may be adjusted independently for each side panel 118 by pivoting the side panel 118 about the side panel twist axis A5. Additionally, the central panel 114 may be rotated (i.e., twisted) about the central panel twist axis A3 to orient the panel direction PD1 at a non-forwardly facing direction relative to the housing 122 (as illustrated in FIGS. 7, 8). For example, the central panel 114 may be rotated about the central panel twist axis A3 to orient the panel direction PD1 in a rearwardly facing direction extending toward the control panel portion 122a, or any position between the forwardly facing direction and the rearwardly facing direction.

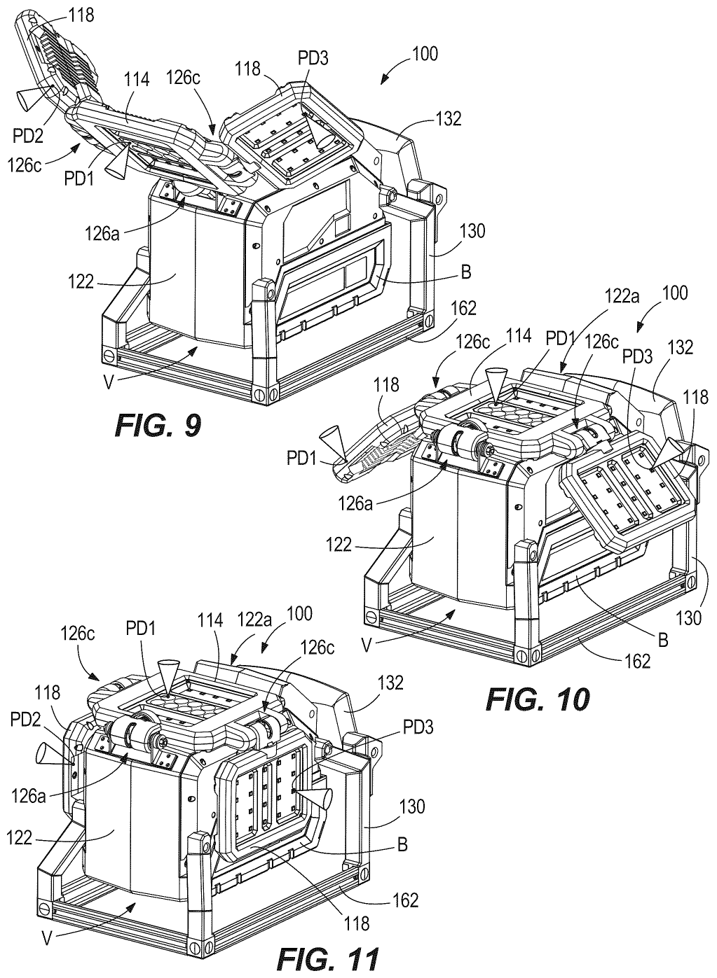

FIG. 9 illustrates another deployed position of the flood light assembly 100 with the central panel 114 pivoted about main panel hinge 126a to face downwardly toward the housing 122. As illustrated in FIG. 9, the central panel 114 is oriented approximately 45 degrees downwardly (with respect to the vertical orientation thereof in FIG. 8). The main panel hinge 126a may be capable of further range of motion to further orient the central panel 114 with the panel direction PD1 thereof facing more vertically downwardly (e.g., 60 degrees or 90 degrees relative to the vertical orientation of FIG. 8). In FIG. 9, the two side panels 118 remain oriented away from the central panel 114 with panel directions PD2, PD3 thereof each facing away from one another and the central panel 114.

FIG. 10 illustrates a partially deployed position of the flood light assembly 100 with the central panel 114 pivoted about the main panel hinge 126a to face upwardly and away from the housing 122. As illustrated in FIG. 9, the central panel 114 is oriented generally parallel to the housing 122, with the panel direction PD1 thereof facing vertically away from the housing 122. In FIG. 10, the two side panels 118 remain oriented away from the central panel 114 with panel directions PD2, PD3 thereof each facing away from one another and the central panel 114. In the partially deployed position, the central panel 114 is retracted vertically inboard toward the housing 122 with the control panel portion 122a extending vertically (as viewed in FIG. 10) above the central panel 114. The control panel portion 122a generally extends beyond the bounds of the remainder of the housing 122. As such, during a drop of the flood light assembly 100, impact between the surface S and the central panel 114 is shielded by the control panel portion 122a near the rear end of the housing 122 and shielded by the main panel hinge 126a near the front end of the housing 122.

FIG. 11 illustrates a stowed position of the flood light assembly 100 with the central panel 114 and each of the two side panels 118 retracted inboard toward the housing 122. In the illustrated embodiment, the housing 122 is shaped generally as a rectangular prism, and the central panel 114 and two side panels 118 are each planar with corresponding sidewalls of the housing 122 when in the stowed position. In the illustrated embodiment, the battery pack B also contributes to the generally rectangular prism shape of the housing 122. The FIG. 11 position orients the panel directions PD1, PD2, PD3 of each of the central panel 114 and two side panels 118 outboard relative to the housing 122. In the stowed position of FIG. 11, the central panel 114 and each of the two side panels 118 are positioned entirely within the void V defined by an outer profile of the housing 122 and the frame 130 such that the central panel 114 and two side panels 118 are shielded from damage during a drop of the flood light assembly 100.

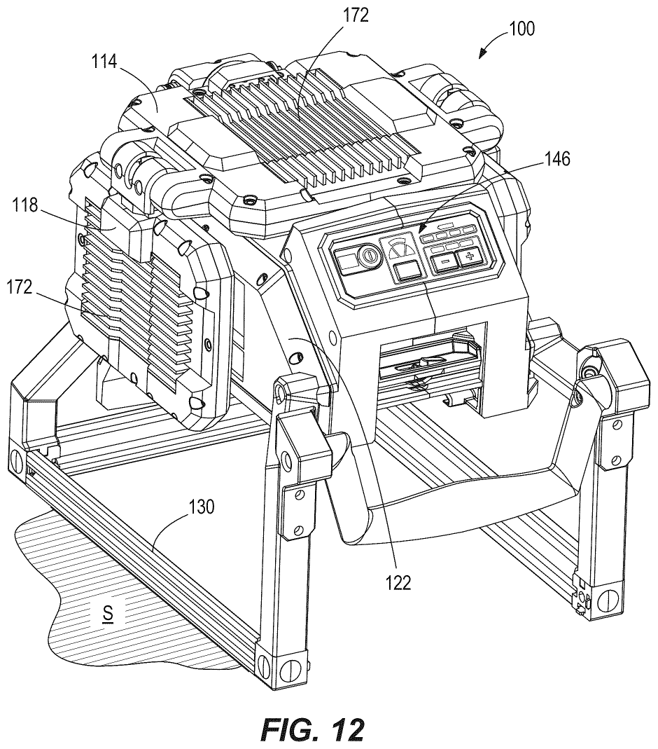

However, the panels 114, 118 of the flood light assembly 100 may be pivoted via the main panel hinge 126a and side hinges 126c to face the panel directions PD1, PD2, PD3 inboard toward the housing 122. FIG. 12 illustrates a stowed position of the flood light assembly 100 with panel directions PD1, PD2, PD3 of the panels 114, 118 facing inboard toward the housing 122. This stowed position may physically shield the spot lights 138 and flood lights 142 from damage, and expose the heat sinks 172 to the surroundings of flood light assembly 100.

With the main panel hinge 126a and side hinges 126c each being multi-axis hinges, each of the central panel 114 and side panels 118 may independently face toward or away from the housing 122. The flood light assembly 100 may include one or more hall effect sensor 158a and magnet 158b pair as described above regarding the flood light assembly 10. The illustrated one or more hall effect sensor 158a and magnet 158b are positioned on the central panel 114 and housing 122, respectively, to detect position and orientation of the central panel 114 relative to the housing 122. Similar arrangements may be provided on the two side panels 118. The flood light assembly 100 further includes a controller 150 like that of the flood light assembly 10 and capable of determining when the central panel 114 is in a stowed position. The controller 150 may gather data or signals from the hall effect sensor 158a and magnet 158b to determine whether the central panel 114 faces toward or away from the housing 122. The controller 150 may optionally calculate that the central panel 114 is stowed and facing the housing 122, and may halt current from being sent to the stowed central panel 114. Additionally or alternatively, the controller 150 may calculate that the central panel 114 is stowed and facing away from the housing 122, and may halt current from being sent to the stowed central panel 114. Similar auto-shutoff patterns may optionally be applied to the side panels 118 in either or both of the inboard facing direction and the outboard facing direction.

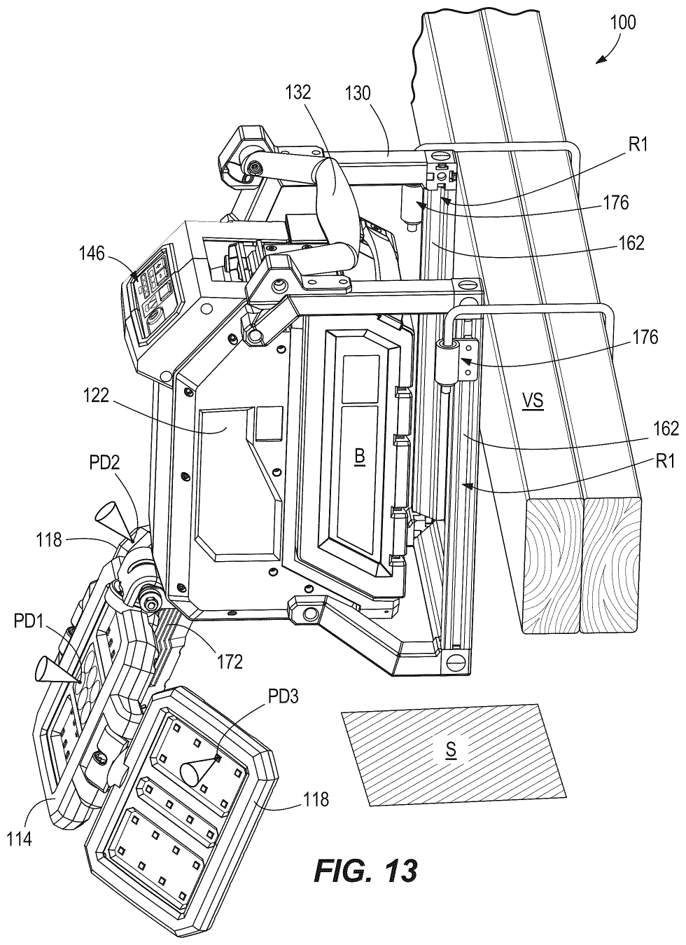

FIG. 13 illustrates the flood light assembly 100 with hooks 176 supporting the flood light assembly 100 on a standing support VS. The hooks 176, or other accessories, engage recesses R1 of the frame tubes 162, as described above regarding the protrusions P1. The hooks 176 may selectively engage and disengage the frame tubes 162 to facilitate transport of the flood light assembly 100 without the hooks 176 mounted to the frame tubes 162. FIG. 13 illustrates a hanging orientation of the flood light assembly 100 whereby the hooks 176 support the housing 122 in a generally vertical orientation relative to the surface S (i.e., ground). In FIG. 13, the central panel 114 is oriented with panel direction PD1 extending away from the surface S, and the two side panels 118 are each non-planar with respect to the central panel 114 with the panel directions PD2, PD3 thereof facing away from each other and the central panel 114. Other hanging orientations are possible, such as and without limitation a horizontal orientation with the housing 122 oriented parallel to the surface S, or with the central panel 114 and two side panels 118 in any deployed or stowed orientation.

Although the disclosure has been described in detail with reference to certain preferred embodiments, variations and modifications exist within the scope and spirit of one or more independent aspects of the disclosure as described.

Various features and advantages of the invention are set forth in the following claims.

1. A light assembly comprising:
a housing configured to couple to a power supply;
a first light panel with a spot light mounted thereto, the first light panel being pivotably coupled to the housing by a first hinge; and
a second light panel with a flood light mounted thereto, the second light panel being pivotably coupled to the first light panel by a second hinge.

2. The light assembly of claim 1, wherein the first light panel includes a plurality of spot lights mounted thereon.

3. The light assembly of claim 1, wherein the first light panel further includes a first light panel flood light mounted thereto.

4. The light assembly of claim 3, wherein the first light panel flood light is one of a plurality of first light panel flood lights mounted to the first light panel.

5. The light assembly of claim 1, wherein the first light panel is coupled to the housing by a first compound hinge including the first hinge, which is pivotable about a first axis, and a yoke arm, which is pivotable about a second axis.

6. The light assembly of claim 1, wherein the first light panel is coupled to the housing by a multi-axis hinge that permits rotation of the first light panel relative to the housing about a central panel twist axis and a different central panel stow axis.

7. The light assembly of claim 1, wherein the second hinge is a multi-axis second hinge that permits rotation of the second light panel relative to the first light panel about a side panel twist axis and a different side panel stow axis.

8. The light assembly of claim 1, wherein the first light panel and the second light panel are movable between a stowed position retracted toward the housing and a deployed position remote to the housing, and wherein at least one of the first light panel and the second light panel face the housing in the stowed position.

9. The light assembly of claim 8, further comprising a sensor configured to determine that the at least one of the first light panel and the second light panel face the housing, and a controller configured to receive communication from the sensor that the at least one of the first light panel and the second light panel face the housing and deactivate the at least one of the first light panel and the second light panel.

10. The light assembly of claim 1, further comprising a thermistor coupled to at least one of the first light panel and the second light panel, and a controller configured to receive communication from the thermistor regarding sensed temperature of the at least one of the first light panel and the second light panel, compare the sensed temperature to a temperature threshold, and deactivate the at least one of the first light panel and the second light panel in an overtemperature condition where the sensed temperature exceeds the temperature threshold.

11. The light assembly of claim 1, wherein the spot light and the flood light are independently activatable by transferring current from the power supply thereto.

12. A flood light system comprising:
a first light assembly including
a first housing configured to be coupled to a first power supply,
at least one first light panel with a first light, and
at least one first frame tube defining a first recess; and
a second light assembly including
a second housing configured to be coupled to a second power supply,
at least one second light panel with a second light, and
at least one second frame tube defining a second recess; and
a protrusion engaging the first recess and the second recess to connect the first light assembly with the second light assembly.

13. The flood light system of claim 12, further comprising a hook engaging at least one of the first recess and the second recess to support the first light assembly and the second light assembly on a support.

14. The flood light system of claim 12, wherein the first light assembly further includes a first controller with a wireless transmitter, the second light assembly further includes a second controller with a wireless transmitter, and the flood light system further comprises a remote control device with a remote user interface configured to selectively activate the first light and the second light.

15. The flood light system of claim 14, wherein the first light assembly further includes a plurality of first lights and the second light assembly further includes a plurality of second lights, and the remote control device is configured to selectively activate desired light or lights of the plurality of first lights and the plurality of second lights.

16. The flood light system of claim 14, wherein the first light assembly includes a first light panel with a spot light, which defines the first light, and a second light panel with a flood light.

17. A light assembly comprising:
a housing configured to couple to a power supply;
a first light panel with a first light mounted thereto, the first light panel being pivotably coupled to the housing by a first hinge;
a second light panel with a second light mounted thereto, the second light panel being pivotably coupled to the first light panel by a second hinge; and
a frame coupled to the housing, the frame including at least one frame tube defining a recess configured to be engaged by an accessory to couple the frame to another object.

18. The light assembly of claim 17, wherein the first light panel and the second light panel are movable by the first hinge and the second hinge between a stowed position retracted toward the housing and a deployed position remote to the housing, and
wherein an outer profile of the housing and the frame together define a void within which the first light panel and the second light panel are positioned in the stowed position.

19. The light assembly of claim 18, wherein the housing defines a protruding portion that partially defines the outer profile.

20. The light assembly of claim 18, further comprising a control panel with a user interface, the housing defining a protruding control panel portion on which the control panel is positioned, the protruding control panel portion partially defining the outer profile.
